(19) United States
(12) Patent Application Publication
(10) Pub. No.: US 2004/0127173 A1
(43) Pub. Date: Jul. 1, 2004

(54) Multiple mode transmitter

(75) Inventor: Gustavo Leizerovich, Aventura, FL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/331,837

(22) Filed: Dec. 30, 2002

(51) Int. Cl. H04B 1/02; H04B 1/04; H01Q 11/12

(52) U.S. Cl. 455/93; 455/126

(57) ABSTRACT

A system and method for providing a highly efficient linear transmitter compatible with a radio capable of operating in one of several modes. In a normal mode of operation, the radio frequency power amplifier (RFPA) runs in envelope tracking mode. Accordingly, the RFPA supply voltage follows the envelope of the linear modulation. In an alternate mode of operation, the supply modulator is locked to a fixed DC voltage. A high efficiency level is maintained in both the normal mode and the alternate mode by using a single agile DC-DC converter to supply the RFPA. The converter input voltage is switched depending on the mode of operation.

### FIELD OF THE INVENTION

The present invention relates generally to communications systems and, more particularly, to a system and method for increasing operating efficiency in a transmitter having multiple modes of operation.

### BACKGROUND OF THE INVENTION

Increasing demand for mobile and personal communications services has renewed interest in spectrally efficient modulation schemes. In addition, the desire for multiple modulation capable mobile stations, such as cellular telephones, for providing greater network compatibility is also growing. For example, particular models of iDEN network compatible mobile stations, available from Motorola, Inc. of Schaumburg, Ill., provide a mode of operation known as Talkaround in addition to a native iDEN mode of operation.

Talkaround is a method of talking around, or bypassing, a repeater to enable a first mobile station to communicate and connect directly to a second mobile station without having to go through the network or a repeater. This enables stations close to each other to talk to one other without tying up the repeater or if the repeater fails.

It is widely recognized that the ideal amplifier for linear modulated mobile systems is a linear amplifier which is also power efficient. Linear transmitters are well known. To achieve both linearity and efficiency in such devices, linearization techniques can be employed in a power amplifier such as a Cartesian feedback loop. A Cartesian feedback loop is a closed loop negative feedback technique which sums the baseband feedback signal to quadrature component signals (e.g., in-phase (I) and quadrature (Q) signals) prior to amplifying and up-converting to an output frequency and a power level. Cartesian feedback of the baseband quadrature modulation provides reduction in intermodulation distortion with low complexity and cost. The systems and methods described above provide for a training method for an RFPA in a Cartesian feedback loop where the supply modulator is locked to a fixed DC voltage during training. This training concept is described in greater detail in U.S. Pat. No. 6,353,359 for a Training Scheme for High Efficiency Amplifier, which is issued to the inventor of the present invention and is hereby incorporated by reference.

However, multiple mode operation for linear and/or constant envelope operation, such as for use in mobile systems having both normal and Talkaround modes of operation, has not been addressed.

### BRIEF DESCRIPTION OF THE DRAWINGS

FIG. 1 is a functional schematic block representation of a transmitter in accordance with an embodiment of the present invention;

FIG. 2 is a diagram of RFPA supply voltage waveforms of the transmitter in a first mode of operation; and

FIG. 3 is a diagram of RFPA supply voltage waveforms of the transmitter in a second mode of operation.

### DESCRIPTION

The novel dual mode transmitter described herein relates to a system and method for providing a highly efficient linear transmitter compatible with multiple mode mobile stations (MS). In a normal mode of operation, such as iDEN mode, the radio frequency power amplifier (RFPA) runs in envelope tracking mode. Accordingly, the RFPA supply voltage follows the envelope of the linear modulation. In an alternate mode of operation, such as Talkaround, the supply modulator is locked to a fixed DC voltage. The dual mode transmitter may be implemented discretely or using a chipset.

A high efficiency level is maintained in both the normal mode and the alternate mode by using a single agile DC-DC converter as the supply modulator to supply the RFPA. The converter input voltage is switched depending on the mode of operation. For example, in an exemplary embodiment, in the normal iDEN mode of operation discussed above, a band limited approximation of the envelope is used. In the alternate Talkaround mode, a fixed DC voltage is used.

A particular advantage of the present multiple mode transmitter system and method described herein is the increase in efficiency and reduction in heat dissipation realized in all modes of operation, including iDEN and Talkaround modes.

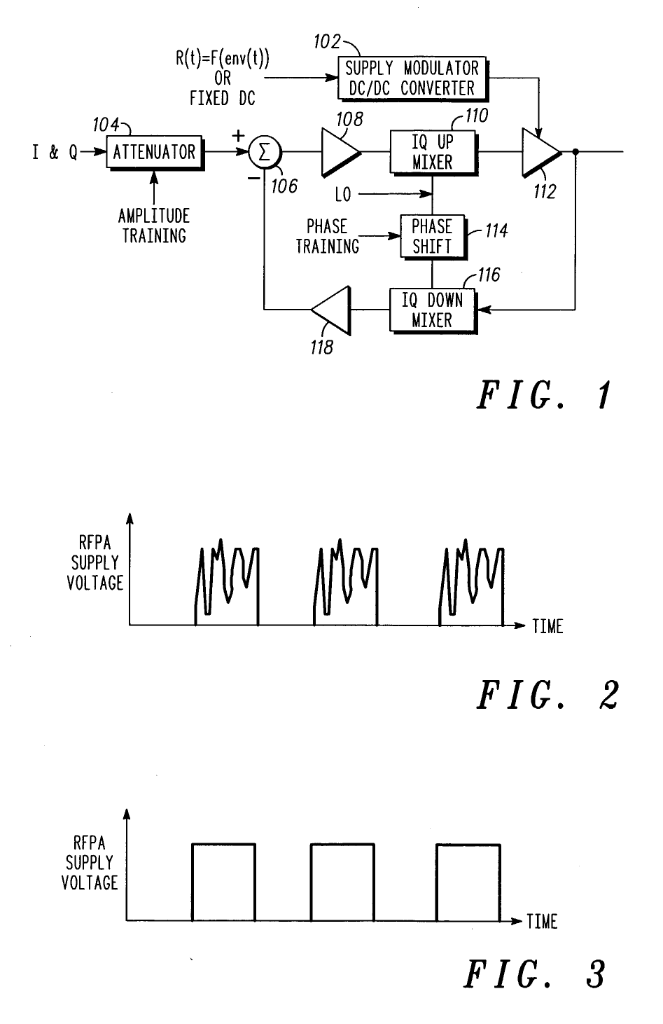

FIG. 1 illustrates a linear transmitter in accordance with an aspect of the present invention. A digital signal processor (not shown) may be employed to provide an input signal to a variable attenuator component 104. The input signal can be a complex digital baseband signal having quadrature components (e.g., in-phase and quadrature signal components). The attenuator component 104 provides an attenuated reference signal which is coupled to a summing junction 106. The summing junction 106 sums or combines the reference signal with a down mixer signal outputted from a first baseband amplifier 118 to provide an error signal as an input to a second baseband amplifier 108. The second baseband amplifier 108 provides gain to the error signal for input into an IQ up-mixer 110. The IQ up-mixer 110 translates the error signal to a required radio frequency (RF) for transmission as determined by a frequency of a local oscillator (LO). The signal is then provided as an input to a RF power amplifier 112, which in turn provides an RF output signal.

A negative feedback correction loop is provided to ensure linear operation of the transmitter 100. Although, the present example of FIG. 1 illustrates a Cartesian feedback loop, other feedback loops may be employed, such as IF feedback and RF feedback loops. It is to be appreciated that any feedback correction that can be facilitated by training may be employed to carry out the present invention. The negative feedback correction loop includes an IQ down-mixer 116 and the first baseband amplifier 118 coupled to the summing junction 106.

The linear transmitter also includes a training mode to provide phase adjustment of a feedback signal with respect to an input training signal and determination of a maximum clip level for the power amplifier. A phase shift component 114 is used to set the loop phase. Amplitude training is also provided to the attenuator 104. Attenuation adjustments and phase shift adjustments are provided in conjunction with a training waveform. Briefly, during training, the system employs a training scheme to the linear amplifier system having a modulator component for modulation of the supply power of the RF power amplifier. The supply modulator is locked or set at a maximum or peak supply voltage of the RF power amplifier that corresponds to a maximum saturation point of the RF power amplifier. Training mode is entered where an input signal is provided and a phase adjustment and an attenuation adjustment level for the RF power amplifier are determined. The phase adjustment and the attenuation adjustment are employed in normal operation.

A more detailed description of the training waveform methodology can be found in U.S. Pat. No. 5,066,923, issued to Gailus et al., for a Linear Transmitter Training Method and Apparatus, which is hereby incorporated by reference. Another training methodology is illustrated in U.S. Pat. No. 5,748,038, issued to Boscovic et al., for a Method for Amplifier Training in a Linear Power Amplifier, which is also hereby incorporated by reference.

A modulator component 102 is provided for modulating an operating point of the RF power amplifier 112. The modulator component 102 is preferably a single agile DC-DC converter and provides modulation of a supply voltage of the RF power amplifier 112. The modulator component 102 receives an envelope signal R(t) representing a function of the envelope F(env(t)) of the RF input signal (I and Q) when the radio is operating in a normal or iDEN mode of operation. Alternatively, the modulator component 102 receives an envelope signal R(t) representing a fixed DC signal when the radio is operating in a Talkaround mode of operation. Thus, the RFPA supply is modulated according to the envelope of the RF signal in order to operate the RFPA closer to its compression point for improved efficiency.

In the normal or IDEN mode of operation, for example, the function of the envelope can be a constant “K” multiplied by the actual envelope signal “R(t)”, or a band limited version of it, to provide an input signal to the modulator 102. The modulator component 102 then employs the envelope signal R(t) to provide an optimal supply voltage to the RF power amplifier 112 for the desired RF output envelope level. The supply voltage of the RF power amplifier 112 is modulated by the modulator component 102 driven by a digital signal processor (DSP) or the like (not shown). The DSP can thus operate to optimize the operation of the RF power amplifier at its most efficient point at a given required instantaneous output power. During normal operation of the linear transmitter 100, the supply modulator portion modulates the voltage supplied to the RF power amplifier to operate at maximum efficiency.

The input signals (I and Q) are inputted into the attenuator component 104. The envelope R(t) is also a function of the input signals (I and Q). Therefore, as the input signals modulate and vary in amplitude, the envelope R(t) modulates and the modulator 102 varies the supply voltage to the RF power amplifier 112. For example, the supply modulation is combined with Cartesian feedback such the R(t) signal is also a function of the error signal in the loop.

In general, a DSP generates a modulation signal that follows or tracks the envelope of the signal to be transmitted. In prior systems, the effect of feedback on the signal, prior to the RF power amplifier, was never considered. In certain situation, such feedback often leads to a deviation from the optimum compression level. In the present system, compression detection or sensing is effected by sensing the I and Q signals and comparing them to the summed results of I+I′ and Q+Q′ after baseband amplification. The compression detection function compares the expected signal with the actual signal and samples at the point before the baseband amplifier (not shown) as well, instead of after it.

The expected signal level is determined is determined by calculation or by mapping, such as with a look-up table. If excess compression is imminent, the signal at the output of the baseband amplifier increases due to the effects of Cartesian feedback. If this comparison indicates that a deviation from an optimum compression level will occur upon RF amplification, the DSP adjusts the modulation signal, thereby deviating it from autonomous correspondence with the envelope of the signal being transmitted.

As shown in FIG. 2, the RFPA supply voltage is operating in iDEN mode, where the supply modulator is following the iDEN envelope. Efficiency is significantly enhanced using the transmitter architecture of the present invention. For example, efficiency increases from 22% on a single ended RFPA to 43% using supply modulation. Furthermore, RFPA heat dissipation in 3:1 mode is reduced from 0.95 W to 0.35 W, which is 63% reduction.

Turning now to FIG. 3, the supply modulator is shown operating in Talkaround mode, where its output is locked to a fixed DC voltage. The efficiency is increased, for example, from 23% to 45%. RFPA heat dissipation is reduced from 2.68 W to 0.977 W, a 63.5% reduction. Because Talkaround operates in continuous mode, the reduction in heat significantly avoids reference oscillator shift and increases battery life. For optimum results, the supply modulator output voltage setting in Talkaround mode is selected to be the minimum required to meet output power specifications, resulting in maximized efficiency. Although not required, the setting is preferably factory tuned.

In another aspect, the dual mode transmitter described herein provides the ability to bypass the DC-DC converter. As such, the battery in Talkaround mode directly feeds power to the RFPA to avoid the efficiency hit of the DC-DC converter. The described bypass mode is particularly useful when the optimum operating point of the RFPA in Talkaround mode is close to the battery voltage. The bypassing method includes, for example, a switch in parallel with the DC-DC converter. Alternatively, the DC-DC converter includes a bypass mode where its internal switches are configured to connect the battery directly to the RFPA in Talkaround mode.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A multiple mode transmitter comprising:
a modulator for receiving one of a plurality of types of signals and for outputting an RF signal corresponding to the received signal, the received signal corresponding to a predetermined operational mode of the multiple mode transmitter; and
an RF power amplifier for receiving the RF signal and outputting an amplified signal, the amplified signal maximizing the efficiency of operation of the transmitter when the transmitter is operating in the predetermined operational mode.

2. The multiple mode transmitter of claim 1, wherein the modulator comprises a single supply modulator configured to output a signal for maximizing efficiency for the operational mode in which the modulator is operating.

3. The multiple mode transmitter of claim 1, wherein the modulator comprises a DC to DC converter.

4. The multiple mode transmitter of claim 1, wherein the output of the modulator follows a signal resembling an RF envelope of the received signal.

5. The multiple mode transmitter of claim 1, wherein the received signal is selected based on a predetermined mode of operation.

6. The multiple mode transmitter of claim 5, wherein the received signal comprises an envelope signal.

7. The multiple mode transmitter of claim 5, wherein the received signal comprises a fixed DC voltage.

8. A radio communication system comprising:
a linear transmitter configured to operate in one of a plurality of operating modes;
an input signal corresponding to the particular mode in which the linear transmitter is operating;
a modulator for receiving the input signal and outputting an RF signal corresponding to the mode in which the linear transmitter is operating; and
a power amplifier for receiving the RF signal and outputting an amplified signal, the amplified signal maximizing the efficiency of operation of the particular mode in which the linear transmitter is operating.

9. The radio communication system of claim 8, wherein the one of a plurality of operating modes comprises an envelope tracking mode.

10. The radio communication system of claim 9, wherein the one of a plurality of operating modes comprises a mode wherein the envelope is substantially constant.

11. The radio communication system of claim 10, wherein the substantially constant envelope mode is a Talkaround mode of operation.

12. A method for increasing efficiency of operation in a multiple mode radio, the method comprising the steps of:
receiving a first input signal corresponding to one of a plurality of operating modes of the radio;
receiving a second input signal corresponding to the RF information signal;
amplifying the second input signal using a power amplifier, wherein the first input signal controls the compression point of the power amplifier according to the operating mode of the radio

13. The method of claim 12, wherein the modulating step further comprises outputting a signal for maximizing efficiency for the operational mode in which the modulator is operating.

14. The method of claim 12, wherein the modulating step further comprises the step of following a signal resembling an RF envelope of the received input signal.

15. The method of claim 12, further comprising the step of selecting the received signal based on a predetermined mode of operation.

16. The method of claim 15, wherein the selected signal comprises an envelope signal.

17. The method of claim 15, wherein the selected signal comprises a fixed DC voltage.

18. In a multiple mode transmitter comprising a signal modulator, a supply modulator, battery and power amplifier, a method for increasing efficiency comprising the steps of:
determining whether the transmitter is in a mode of operation wherein the envelope is substantially constant; and
bypassing the supply modulator for preventing operation of the supply modulator when the transmitter is in the substantially constant envelope mode.

19. The method of claim 18, wherein the bypassing step further comprises the step of directly feeding power from the battery to the power amplifier.

20. The method of claim 18, wherein the bypassing step comprises a switch connected in parallel with the supply modulator for connecting the battery directly to the power amplifier.

21. The method of claim 18, wherein the supply modulator comprises internal switches for connecting the battery directly to the power amplifier.

22. The method of claim 18, wherein the substantially constant envelope mode of operation is a Talkaround mode of operation.
